(19) United States
(12) Patent Application Publication
(10) Pub. No.: US 2018/0373243 A1
(43) Pub. Date: Dec. 27, 2018

(54) System and Method for Safe Utilization of Unmanned Automated Vehicles in Entertainment Venues

(71) Applicant: David Wayne Russell, Winter Garden, FL (US)

(72) Inventor: David Wayne Russell, Winter Garden, FL (US)

(73) Assignee: USDrobotics Inc., Orlando, FL (US)

(21) Appl. No.: 16/063,571

(22) PCT Filed: Dec. 28, 2016
(86) PCT No.: PCT/US16/68925

§ 371 Date: Jun. 18, 2018

Related U.S. Application Data
(60) Provisional application No. 62/274,222, filed on Jan. 1, 2016.

(51) Int. Cl. G05D 1/00; B64C 39/02; G05D 1/02; G08G 5/00; G08G 5/04; A63H 30/04

(52) U.S. Cl. CPC G05D 1/0055; G05D 1/0088; B64C 39/024; G05D 1/0204; G08G 5/0039; B64C 2201/088; G08G 5/045; A63H 30/04; B64C 2201/12; B64C 2201/028; B64C 2201/145; G08G 5/0069

(57) ABSTRACT

Entertainment venues such as theme parks, water parks, stadiums and the like would be prime venues for choreographed UAV exhibitions if they could be made safe. An Application Specific Autonomous Vehicle is described which is safe for operation in close proximity to human spectators without the need for an external computerized control system or pilot control.

### FIELD

The field of the invention relates generally to the safe operation of autonomous vehicles and more specifically to safe utilization of unmanned automated vehicles in entertainment venues.

### BACKGROUND

Large entertainment venues such as theme parks, water parks, sports stadiums and concert venues are exceedingly risk averse when it comes to endangering the guests. While they acknowledge that a “drone” based entertainment show would be attractive, there are too many variables and risks, and too little understanding of drone operation to consider it safe.

There exists the need for some mechanism which provides a high probability that if a drone platform were to malfunction or be taken by a gust of wind that it would not harm a guest. Speed is the primary determinant of accuracy and accuracy equates to safety. The first requirement of a safe system is to eliminate the human pilot. In any emergency situation, the human pilot may have better situational awareness, but these high speed and low altitude platforms do not provide enough time for human reaction.

Vehicle to Vehicle (V2V) communication and monitoring are useful in preventing vehicle collisions but is insufficient to guarantee guest safety, nor is a global external guidance system. The RF environment within these large venues is too crowded for any reasonable guarantee of service metric. A system is needed for an Application Specific Autonomous Vehicle which is designed and constructed to be safe for operation in close proximity to human spectators without the need for an external computerized control system or pilot control.

### BRIEF SUMMARY OF THE INVENTION

To enable a safety protocol and mechanism within the vehicle, the vehicle is not flown by an operator or ground controller but a via pre-computed and timed trajectory which includes the definition of a safety area. This pre-computed trajectory will hereafter be termed the trackpath. The trackpath and the Free Flight Corridor (FFC) construct within the trackpath data object is used to choreograph the movement of the Unmanned Autonomous Vehicle (UAV) safely within the venue.

To execute the trackpath from the UAV, a specialized controller may be implemented within the platform such as but not limited to a Safe Temporal Vector Integration Engine (STeVIE). These two elements guarantee that the UAV will not cross the FFC construct separating the UAV operational space from the guest/spectator space.

When flying above human occupied space, the concept of Safe Terminal Guidance is employed to either find a safe point to land or mitigate in some manner the terminal velocity and impact force of the vehicle. In addition, the UAV itself may be configured as an Application Specific Autonomous Vehicle (ASAV) in that it is specifically designed and equipped for entertainment purposes such as but not limited to pyrotechnics, lighting, and special effects.

### BRIEF DESCRIPTION OF DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 shows an overall plan and side view of a UAV configured specifically for entertainment venues.

FIG. 2 depicts the Terminal Guidance System flow chart.

### DETAILED DESCRIPTION OF INVENTION

The following detailed description illustrates embodiments of the invention by way of example and not by way of limitation. The description clearly enables one skilled in the art to make and use the disclosure, describes several embodiments, adaptations, variations, alternatives, and use of the disclosure, including what is currently believed to be the best mode of carrying out the disclosure. The disclosure is described as applied to an exemplary embodiment namely, systems and methods of safely managing unmanned vehicles in entertainment venues. However, it is contemplated that this disclosure has general application to vehicle management systems in industrial, commercial, military, and residential applications.

In one embodiment, an Unmanned Autonomous Vehicle (UAV) is comprised of some combination of an airframe, motive power unit (MPU), flight control system (FCS) and show control system (SCS). In another embodiment the airframe may be implemented as a wheeled or other ground surface vehicle, aquatic surface vehicle, or sub-surface vehicle.

The vehicle is autonomous in the sense that it does not require input from external services such as a human pilot or pilots, external controller, or external computer swarm controls which are used to direct and/or adjust the movement of the vehicle(s) in real time. Instead, the FCS is pre-loaded with a trackpath data structure which combines the navigational and timing data needed by the FCS with temporal specifications (Temporal Vectors) as to where and when the vehicle should be at any given time and the additional data of X, Y, and Z attitude rotations and translations within that Temporal Vector framework. This allows, for example, for the attitude of the platform framework or body to be independent from the direction of flight, if the platform design and construction supports such flexibility.

In addition, the trackpath data includes the concept of a Free Flight Corridor (FFC), a construct of one or more dimensions, for example without limitation four, which provides a specific limitation of the area within which the vehicle must operate, also sometimes denoted as an Inverse-Geofence. This FFC structure could, for example, but implemented as a sphere around the center point of the vehicle, but it also allows the fence to vary over time such that it may be large at some point in the show and small in another, spherical one moment and cubical, conical, or cylindrical at others. The FFC could also be interpreted as a given altitude floor, ceiling, or both.

Additionally the trackpath data object is not only the navigational and fence 4D data but also a programming language capable of logical decision making dependent on the input data received from the platform sensors. Multiple trackpaths may be stored within a single vehicle, and the vehicle may switch from one trackpath object to another based on conditions it encounters.

In another embodiment similar constructs or similar data under a different nomenclature could be implemented in software and run on a standard processor within the UAV without altering the intent of this invention.

In order to implement the navigational, safety, and logic directives of the trackpath data object in a timely manner, one embodiment of this system is to implement the FCS as two interconnected hardware systems denoted as a Safe Temporal Vector Integration Engine (STeVIE) and a platform control system denoted as a Vector In-Guidance Out (VIGO) engine.

STeVIE's systems perform obstacle avoidance, scene analysis, and location analysis to determine at any point in time the difference between the current location and attitude of the vehicle, modeled as a point in space, and the programmed location at the same point in time given by the trackpath data object.

It also integrates vectors for obstacle avoidance, swarm and/or vehicle formations, and other data to produce one final vector that takes it from its current location and attitude to its next (delta-T) location and attitude. This temporal vector is passed without limitation up to one million times per second to VIGO for execution.

VIGO is not required to know anything of the route or planning requirements of the platform, but is built to efficiently implement non-linear problems through mathematical algorithms such as but not limited to any combination of fuzzy logic and/or neural network algorithms to implement the nonlinear characteristics of the individual platform's flight control system. VIGO responds to the vector provided by STeVIE by dynamically adjusting the flight control surfaces and parameters such as but not limited to power, RPM, and/or nacelle attitude of the MPU.

In another embodiment similar algorithmic constructs or any others that would equally meet the mission requirements could be implemented in software and run on a standard processor within the UAV without altering the intent of this invention.

The Show Control System (SCS) is the portion of the UAV that defines it as an Application Specific Autonomous Vehicle (ASAV). Under most circumstances a given UAV with autonomous capabilities would be synchronized to some common clock standard such as but not limited to GPS or Universal time standards. An ASAV operating in an entertainment environment may still be standardized to these time systems but also needs to be synchronized with audio, lighting, and other entertainment systems in the venue. This is often referred to as SMPTE time named from the Society of Motion Picture Technical Experts standard which is utilized to synchronize these disparate show control entities.

In another embodiment other standards and transmission protocols such as but not limited to FSK may be employed and in some instances all of the show controls systems may be synchronized to one universal standard such as GPS, GMT, or Universal time.

In addition to synchronization with the show control system time standard, the ASAV may be specially equipped with entertainment functions such as but not limited to pyrotechnic control systems, lighting systems, sound systems, smoke and flame effects, and releasable functional packages.

The primary purpose of the time synchronization is to ensure that the movement of the UAV coincides with the rest of the show elements, but it is also of critical importance that the Show Control System (SCS) on the platform can execute show elements such as lighting and other special effects from the platform, rather than having to be directed via radio signal or other communications means from the ground-based show control system. This enables the platform to be a Master show control element, rather than a slave and significantly reduces the amount of RF traffic, time latency, potential for error, and bandwidth requirements of the overall show control system.

In one embodiment a wireless pyrotechnic control system may be utilized to sequence and fire pyrotechnic devices safely in dynamic and highly crowded RF environments. In addition to the normal safety devices and protocols provided by the pyro control system, the ASAV implements additional safeties based on timing, location, attitude, and scene analysis data that is not available to the controller directly.

For example the pyro system may know of no disable logic or condition that would prevent the firing of a pyrotechnic device, but if the location and attitude of the platform is not within designed tolerance at the time of the launch, the FCS system would automatically abort the device firing. This can only be accomplished if the ASAV platform is acting as a Master controller, not a Slave. In another embodiment scene analysis and obstacle avoidance systems could also be called on to validate that no obstructions, unexpected structures or humans have entered the path of the vehicle or the path the pyrotechnic device might take upon firing.

Because of the precise guidance of the FCS platform and the extended lift capability of the MPU ASAV units may be able to take the place of scene spotlights, area lighting, and other illumination tasks both functional and as part of the entertainment show. For example high intensity lighting which would have required mains power and a scaffolding of some type to be placed in a specific location can now be implemented in free space by a lighting ASAV utilizing high power on-board motor-generator power systems. Most lighting systems are based on a control protocol such as but not limited to DMX or DMX-512 and these protocols can be transmitted wirelessly to or stored within the SCS of the ASAV as well.

In some case, releasable packages may be attached to the ASAV. These packages could contain any safe delivery medium such as but not limited to paper coupons, confetti, edible items, and the like. In addition it may be a package utilized in conjunction with the show and SCS for other special effects. In one embodiment the ASAVs may be enacting a combat scenario. If the ASAVs are brilliantly lit, then a LASER beam or close proximity blast could be timed such that the ASAV goes dark and the package is dropped and ignited by the pyrotechnic system, providing the illusion that the ASAV had been hit and crashed.

In another embodiment Enhanced-GPS, illuminated beacons, or Acoustic Local Positioning Systems (ALPS) could be implemented within the venue area to enhance the accuracy of the on-board positioning sensors of the ASAV.

In practice, the ASAV is loaded with the appropriate trackpath data structure or structures for its show while at a disembarking location such as a nearby maintenance shed. Here it may also be serviced, fueled and/or electrically charged, and loaded with any consumables such as pyrotechnics, confetti, or other show requirement. The ASAV synchronizes its on-board clock with the universal and/or show time systems as necessary, and then is given an enable signal by the show control supervisor at some time prior the pre-loaded lift-off time given in the trackpath. Because each trackpath data object can be different, each ASAV may have the same or different launch and return times.

Once launch time arrives, the platform executes the trackpath navigation, safety, and attitude instructions while simultaneously performing obstacle avoidance, swarm and formation flying adjustments and FFC avoidance throughout the show. It is possible that multiple trackpath segments may be executed within a single show. For each vehicle, perhaps at different times, the trackpath will provide the instruction and timing to return to the maintenance bay and shut down for service.

The primary difference between a fully autonomous system utilizing trackpath objects and an externally programmed show supervisor based system is apparent in the cases of deviation from path and imminent safety violations. In a trackpath system there are no Single Points of Failure (SPF). Both the trackpath interpreter and the obstacle avoidance system monitor the location of the nearest FFC construct and the distance, velocity, and acceleration of the platform towards that construct.

While the FFC construct is part of the trackpath definition being executed by the platform, the FCS also implements the concept of a Soft Fence. Depending on the altitude, speed, and capability of the ASAV the Soft Fence is calculated on a moment-by-moment basis as an offset point between the current location of the platform and the nearest point on the FFC. If the platform reaches this point, it can be assumed that it has exhausted all of its other capabilities to try to get back on track, and we are now approaching an emergency situation. This is the point where the Terminal Guidance System (TGS) is invoked within the FCS.

Terminal Guidance has two approaches it can invoke: First, land the vehicle safely, and second do everything it can to prevent injury to humans. The Obstacle Avoidance system changes mode from avoidance to acceptance—it is now searching the immediate area under and around the vehicle for a safe landing point. If it finds one and the FCS is successful in navigating to it, it may land.

In some cases, however, the platform reached this point because of either internal failures such as one or more engine failures or external forces such as a high wind gust, and it may not be able to navigate safely. The TGS will quickly recognize whether or not guidance is active and if navigation has failed the TGS will put the engines in a Safe Descent Mode where a maximum rate of descent is maintained even if navigation has failed. This is to mitigate the terminal velocity of the platform as it descends, giving humans time to anticipate and move or minimize the impact velocity. If the TGS determines that no mitigation of terminal velocity is being accomplished, the TGS can then cut power to the engines and deploy other devices to mitigate terminal velocity and impact force such as but not limited to a parachute and air bag.

An external show direction system must be programmed to anticipate and react to every conceivable failure and combination of failures, which is combinatorically impossible. A safety system implemented within the ASAV only has to deal with its own failure modes and the system remains safe.

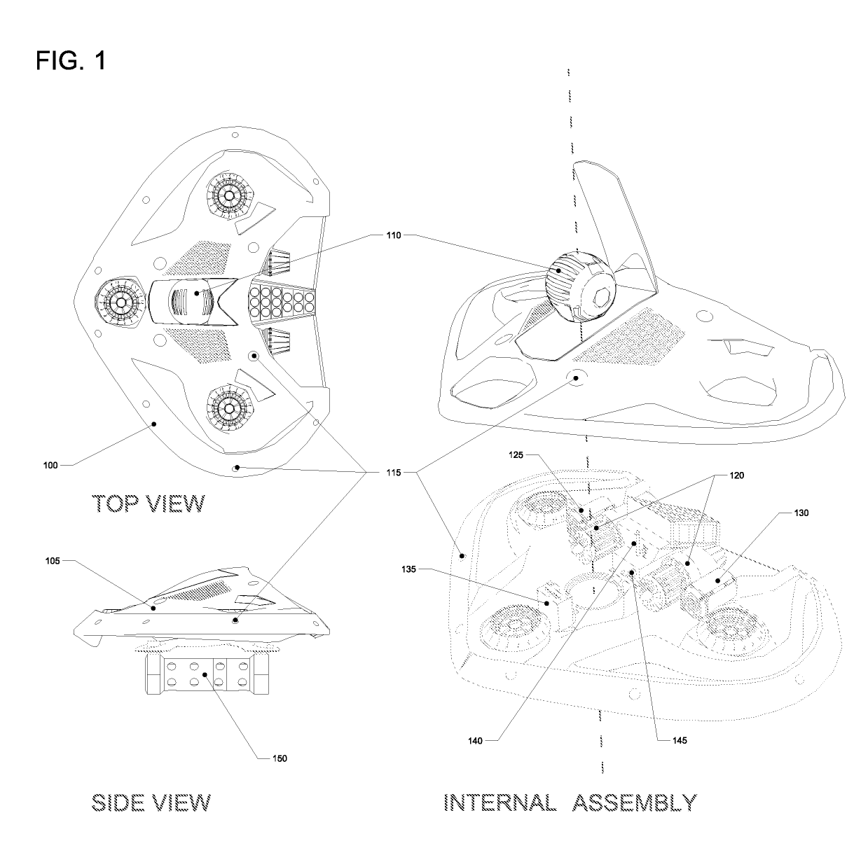

FIG. 1 shows an overall plan view 100 and side view 105 of an Unmanned Autonomous Vehicle configured specifically for entertainment venues. In order to be safe for operation in theme park and large venue environments, we must first define what “Safe” means. In order to protect humans from injury, “Safe” in an entertainment context means A) No single point of failure. Logical, computer, and control systems must be designed so that the failure of any one component will not cause a loss of positive control. Power systems must be redundant and one motor may be lost without loss of positive control.

B) The platform or any part thereof may not cross the FFC without positive control or without some method of mitigating terminal velocity and impact force. This implies, for example, that a spinning propeller blade cannot break off and fly outside the FFC into the guest area. In one embodiment this can be attained by utilizing ducted fan motive units instead of simple propeller blades. Ducted fan units may be static or gimballed to impart vectored thrust allowing more freedom in the flight direction and attitude of the ASAV platform. In some embodiments additional safety features may be added as dictated by the environment and mission such as but not limited to

C) Nine Zeros Safe: the highest probability malfunction consisting of multiple points of failure in the safety or control systems should be less than 0.0000000001 in 1000 hours of operation.

D) Privacy: Safe vehicles operating in public areas may have image sensors for obstacle avoidance and scene analysis but cannot store or transmit images.

E) Hack Resistant: Software systems are susceptible to cyber attack, subversion, and spoofing. Control and safety systems should be primarily implemented from hardware constructs and architectures for speed and security. Radio Frequency based system sensors such as GPS should have secondary systems for validation, and a safe failure mode if the validation fails. Large venues dependant on RF communication for show control are susceptible to a simple jamming attack.

F) RF Shadows: in the radio bands currently in use such as the 2.4 GHz and 5 GHz ISM (Instrumentation, Scientific, and Medical) bands reception of the signal from the source transmitter is Line Of Sight. Physics dictates that any object larger than the antenna will block or reflect the radio signal. This produces “shadows” of poor reception in the venue area which are not readily discernable to the operator. Implementation of a mesh network between the platforms is one solution to the shadow problem. If a platform enters an area shadowed from the source transmitter, the signal may still be routed through the network to reach the platform from another angle or direction.

Mesh networks, however have their own side effects such that they tend to communicate with each other so much that if the network grows to more than 10 or 20 nodes is significantly restricts the throughput of the show control system. In this ASAV system additional proprietary algorithms may be added on top of the mesh network to alleviate these problems. Theme parks and large venues are especially crowded RF environments and any system which requires a high reliability of RF communications is difficult to consider safe.

G) Fail Safe operation—when systems fail, they should be Correct By Construction designed to fail in a safe manner.

The plan view shows the Flight Control System 110. In one embodiment these are implemented in hardware specialized systems such as but not limited to a Safe Temporal Vector Integration Engine for navigation and Vector In Vector Out engine for platform and Motive Power Unit control. In other embodiments combinations of hardware and software systems could be mixed as safety, speed, and computational power allow.

Because the overall system is autonomous and not reliant on external communications links for safe navigation and control, only one RF data link is required but in some cases two or more might be implemented for specific requirements. This link is primarily used to keep all systems synchronized and provide Safety Override and Return to Base (RTB) capabilities in case the show is stopped or cancelled for any reason.

The FCS is connected to the platform sensor system 115. This sensor system may contain sensors such as but not limited to 3D image analysis systems, scene analysis systems, Inertial Measurement Units, GPS, Enhanced GPS, Audio Local Positioning Systems (ALPS), gyro compass, magnetic compass, barometer, proximity detector, light sensors, IR sensors, audio sensors, temperature sensors, LASER, LIDAR, RADAR, or other systems. External sensors might also be utilized and the data reported to the platform over RF, IR, or other wireless system.

The purpose of these sensors will be dependent on the capabilities and requirements of the platform for the particular show. The minimum sensor capability needed for the FCS to perform is location determination and obstacle avoidance. Other embodiments might include sensors for detecting other vehicles for swarm and/or formation flying. Some sensors may be connected to STeVIE in the FCS, others to VIGO, and some to both.

In another embodiment, in addition to sensors on board the platform, the venue may implement any combination of additional directional, location, timing, and safety system data which can be broadcast or detected within the venue for increased accuracy and safety of the platform such as but not limited to Enhanced-GPS, Audio Local Position Systems, LIDAR, RADAR, IR or visible light beacons, actor position tags and sensors, or RFID such that the accuracy of the system is enhanced or the safety of the system is enhanced.

VIGO in the FCS is also connected to the motor power units and the motors 120 and the motor-generator power units 125 and 130. To meet the standard for safety stipulated in this embodiment of the system two power units are required to prevent a single point of failure. The minimal power necessary from one power unit should be sufficient to power the system for the maximum anticipated distance and time required to make a safe controlled landing in that particular venue. It is therefore conceivable that a battery unit could be used a backup to a motor-generator system, or if power requirements of the show are low then two battery systems could be implemented. In another embodiment two motor-generator systems or separate motor and generator systems could be implemented.

The FCS is also attached to the Show Control System (SCS) 135. The FCS knowledge of current time and location is used in conjunction with logical statements in the trackpath code to enable and/or disable events defined in the show control system. In one embodiment all elements of the show control system event timing, also commonly called the choreography of the show, are embedded within the trackpath timing and event system.

In another embodiment the show choreography is stored within and executed by the SCS with cooperative control from the FCS and trackpath system. In one case external safety and synchronization signals may be received and acted upon by the SCS itself, by the FCS and SCS in cooperative control or just the FCS with appropriate data and control signals sent to the SCS. For example, the SCS could be connected to a pyrotechnic firing module 140. In one embodiment the module may contain its own RF transceiver, choreography storage, and safety system independent of the platform but with override disables from the SCS and/or FCS routed to the module.

In another embodiment information from the SCS/FCS could be transmitted to an external pyrotechnics control system which would then evaluate the data in conjunction with the human operator and other safety control data to make the final determination of go/no go for the pyrotechnics and transmit enable and disable signals directly to the modules as appropriate. In another embodiment the pyrotechnic module could be “dumb”, providing only power and timing, and all safety and control would be handled by the SCS/FCS within the platform, or by an external system.

Similarly a lighting control system 140 or the drop unit 145 attached to or part of the ASAV could be entirely controlled by a separate system within the platform, by the SCS/FCS, by and external system, or a combination of all of these. The other entertainment functionality of the ASAV such as but not limited to audio systems, environmental lighting systems, LASER systems, smoke or special effects systems, fire projection systems, video projection systems, and video recording systems would be implemented within a similar control architecture.

The Scene Analysis system as mentioned above can also change which trackpath structure is currently being executed, such that external events visible or detectable from the platform (such as but not limited to a narrow beam directed RF energy signal, a detectable target such as but not limited to a wrist band, LASER, or visible light from elsewhere in the venue) could be used to alter the behavior of the platform. One use for this would be a system wide RTB or shutdown signal in case of emergency. The scene analysis and obstacle avoidance systems along with potentially other specific sensors may be used in combination to allow the flight control system to fine tune, alter, or synchronize the behavior of the platform for example without limitation in swarm configurations or formation flying.

The scene analysis system may also be used to determine, by recognition, reception, or detection of an external event, signal, or combination of events and signals such as but not limited to guest preferences, permissions, achievement points, game play, interaction with ground-based or portable gaming devices, park area, time, of day, or date which particular special effect, function, or trackpath should be initiated.

It is also possible for a trigger event or combination as stated could be broadcast to other vehicles either directly or via ground-based communications or via the show control systems to notify other vehicles of the trigger event and initiate swarm, synchronized, or other activities. These decisions within the platform to alter the current trackpath or switch to another pre-programmed trackpath may be transmitted back to the overall show control system for monitoring and coordination. This monitoring function may include information such as but not limited to status information, error flags, and maintenance information.

In another embodiment ground based, portable, or other effects such as but not limited to bullet hits, audio and/or video playback, mist, spray, animatronics, foam, snow, spray, confetti, glitter, lighting effects, flame, spark showers, image audio and/or video capture could be initiated by proximity of or the anticipated proximity of the platform to the ground effect or by transmission of coded information from the platform to the ground effect or to the overall show control system connected to the ground effect.

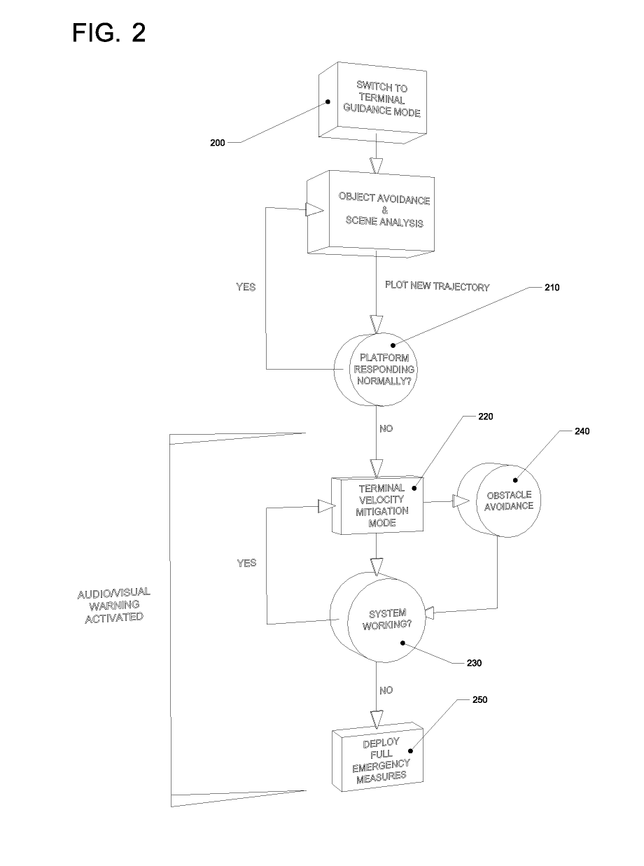

FIG. 2 depicts a flow chart of a Terminal Guidance System (TGS). This system is always running in parallel with the FCS and has access to many if not all of the same sensor systems. Essentially if either the FCS or the TGS determines that an emergency condition exists, the TGS can take control of the platform. The detection of an emergency condition prompts the switch to TGS mode 200.

The TGS system may be implemented as a completely separate set of hardware/software control elements or it may share some functionality with the FCS as long as the primary “No SPF” condition is met. Utilizing the Object Avoidance and Scene Analysis systems, the TGS independently plots a safe landing location and vector. It passes this vector to VIGO for implementation, and then monitors the platform's response 210.

If the platform is responding within acceptable parameters, the TGS continues to vector the platform to the safe landing. If the platform is not responding, the TGS switches to terminal velocity mitigation mode 220 and attempts to descend in an uncontrolled manner but slowed by the platform's engines. Again the TGS monitors the platform's performance 230 and if it is responding within acceptable parameters it continues in this manner until a safe landing is accomplished.

In addition the obstacle avoidance system is still active, and if the system anticipates that the landing area is obstructed 240 or in particular a human is directly beneath the platform, it will attempt to further retard or reverse the descent until the landing area is determined to be clear. If the platform is not descending at an acceptable rate a full emergency is declared and engines are cut as it is unknown whether they are helping to mitigate the emergency or possibly causing it. With the engines cut the TGS then deploys its remaining capabilities to mitigate terminal velocity and impact force 250.

In one embodiment these could be items such as but not limited to parachutes and/or air bags. In another embodiment guest warning devices such as audio warning sirens or beepers (such as used in heavy equipment when backing up) and/or strobe or rotating lights. The platform might also employ a LASER within human safety guidelines or spotlight to focus attention on the projected area of impact as additional warning to the guests.

In another embodiment markers identifiable by the platform such as but not limited to visible markings, IR beacons, or RF beacons might speed and simplify the identification of safe landing areas to assist the platform.

In another embodiment the vehicle need not be an aeronautical one but could also be a road or off-road vehicle, a land vehicle within a stadium or large stage venue, a water surface craft or sub-surface craft.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

The invention claimed is:

1) An Application Specific Autonomous Vehicle designed and constructed to be safe for operation in close proximity to human spectators without the need for an external computerized control system or pilot control.

2) The system of 1 where safety is achieved by utilization of an FFC construct, a one or more dimensional data object defining prohibited areas and self-contained autonomous flight control system

3) The system of 1 where safety is achieved by coupling a self-contained autonomous flight control system with a show-synchronized autonomous show control system.

4) The system of 1 with a hardware flight control system implemented as a Safe Temporal Vector Integration Engine and Vector-In Guidance Out coprocessor.

5) The system of 1 where the flight control and safety systems are implemented in any combination of hardware and/or software processors and sensor systems.

6) The system of 1 with a safety Terminal Guidance System in case of emergency landing.

7) The system of 1 where detection of emergency landing locations by the system is assisted by markers identifiable by the system which may or may not be visible to the guests.

8) The system of 1 where the platform contains no Single Point Failure mechanisms in safety critical systems.

9) The system of 1 which is designed to fail safe.

10) The system of 1 where safety capabilities may include parachute and/or airbag deployment.

11) The system of 1 in combination with a special effects system which combines safety information derived from the platform Flight Control System to implement a Master Show Control System for safe control of pyrotechnics or special effects such as but not limited to smoke, colored powders, scented fluids, glitter, confetti, water, fog, lighting, flame, spark shower effects, bubbles, simulated snow, foam, spray, slime, audio playback, image, video, and/or audio capture, target detection, or glow in the dark materials.

12) The system of 1 where the effect selected by the internal show control system is determined by any combination of sensor detected information, programmed information included in the trackpath data structure such as but not limited to guest preferences or permissions, achievement points, game play, interaction with ground-based or portable gaming devices, park area, time of day, or date.

13) The system of 1 where detection of a trigger event, constellation of events, or aggregation of events by one platform can cause a broadcast by that vehicle to inform other vehicles either directly or through other ground based communications or show control systems of the trigger event which could cause them to switch to other trackpath actions such as but not limited to swarm performance or synchronized special effects playback.

14) The system of 1 where any combination of proximity and/or timing information transmitted from the platform or detected by ground-based systems could inform the ground based show control system to trigger ground-based special effects to coincide with the timing of the independent action of the platform.

15) The system of 1 where the flight control system may switch trackpath data objects to alter the behavior of the platform or otherwise trigger application specific functions or behaviors based on information sensed from the environment.

16) The system 1 where status information from the flight control system and the show control system may report status information back to the overall show control system.

17) The system of 1 where swarm or formation flying information from other vehicles may be sensed by the scene analysis system and utilized by the flight control system and show control system to alter, fine tune, or synchronize the behavior of the platform.

18) The system of 1 where the platform may alter its active trackpath based on internal information such as but not limited to internal status, error, and maintenance requirements.

19) The system of 1 where other safety or guest experience protocols could be implemented such as but not limited to finding and tracking a lost child, executing a preplanned maneuver, function, or special effect when a particular guest is detected, alarm activation, or gift distribution.

20) The system of 1 where any combination of additional directional, location, timing, and safety system data is broadcast within the venue for increased accuracy and safety of the platform such as but not limited to Enhanced-GPS, Audio Local Position Systems, IR or visible light beacons, or RFID such that the accuracy of the system is enhanced or the safety of the system is enhanced.
